(19) United States
(12) Patent Application Publication
(10) Pub. No.: US 2025/0249391 A1
(43) Pub. Date: Aug. 7, 2025

(54) GAS RECOVERY DEVICE

(71) Applicant: HONDA MOTOR CO., LTD., Tokyo (JP)

(72) Inventor: Hidetaka OZAWA, Saitama (JP)

(21) Appl. No.: 19/023,339

(22) Filed: Jan. 16, 2025

(30) Foreign Application Priority Data
Feb. 1, 2024 (JP) 2024-014429

(51) Int. Cl. B01D 53/04; B01D 53/14

(52) U.S. Cl. CPC B01D 53/0454; B01D 53/1475; B01D 2257/504; B01D 2259/40003

(57) ABSTRACT

A carbon dioxide recovery device includes: a plurality of modules which execute an adsorption process and a desorption process; and a fan provided in a smaller quantity than a quantity of the plurality of modules, and supplying a gas to inside of the plurality of modules, in which each of the plurality of modules includes a third valve, a fourth valve respectively at an inlet and an outlet of gas, and the fourth valve hash a valve aperture which varies according to an adsorption progression of carbon dioxide in the module to which the fourth valve is provided.

This application is based on and claims the benefit of priority from Japanese Patent Application No. 2024-014429, filed on 1 Feb. 2024, the content of which is incorporated herein by reference.

### BACKGROUND OF THE INVENTION

### Field of the Invention

The present disclosure relates to a gas recovery device.

### Related Art

As a gas recovery device, for example, technology for recovering carbon dioxide from a gas which contains carbon dioxide such as atmospheric air has been known conventionally. As a document disclosing this type of technology, Japanese Unexamined Patent Application, Publication No. 2019-98220 can be exemplified. Japanese Unexamined Patent Application, Publication No. 2019-98220 discloses a collection/discharge device for carbon dioxide which uses a blower unit introducing outdoor air to send it an adsorption unit.

When adsorption progresses using a sorbent material in an adsorption process, the gas adsorption capacity of the sorbent material (gas adsorption rate) gradually declines. Although it is desirable to expose a large amount of atmospheric air to the sorbent material at the initial stage of the adsorption process because adsorption of a large amount of gas being possible, it is unnecessary to expose a large amount of atmospheric air to the sorbent material in the final stage of the adsorption process.

In Japanese Unexamined Patent Application, Publication No. 2019-98220, an adsorption unit (adsorption module) including an adsorbent, and a sending unit are arranged in a one-to-one ratio. While it is necessary to perform air blowing in the adsorption process, since air blowing is unnecessary in the desorption process, the fan of the blower unit can also be stopped. However, the fan is prone to failure due to a great amount of electric power being necessitated during startup of the fan and repeated startup and stop.

In addition, it has been considered to more efficiently perform gas adsorption by providing a plurality of adsorption modules, and configuring so as to sequentially perform adsorption and desorption at staggered timings. In this case, if arranging a plurality of adsorption modules and configuring so as to perform adsorption and desorption sequentially at a staggered timings, and performing the blowing of gas to each adsorption module collectively by one fan, it is possible to more efficiently perform gas recovery, while always driving the fan.

For example, in a case of adopting a value such as ta:td=7:1, for example, for the ratio of a time length ta of the adsorption step in which air is passed through a corresponding adsorption module in the adsorption step of a gas, and td which is the total of the time length not involved in air flow, such as a preheating step for gas desorption and the desorption step, and further a cooling step for the adsorption preparation, a configuration can be established such that defines one group as adsorption 7 modules+desorption 1 module=8 modules, and defines a positive number multiple of this group as one unit of the gas recovery device. In this case, for example, by delaying the step-time transition of each module by (ta+td)/8 for this group of 8 modules, and configuring so that adsorption completes in sequence, and then the desorption step is performed in sequence, efficient heat management can be achieved by configuring so that a module somewhere is always fulfilling the desorption step.
Patent Document 1: Japanese Unexamined Patent Application, Publication No. 2019-98220

### SUMMARY OF THE INVENTION

However, in the case of arranging a plurality of adsorption modules and performing blowing with one fan, even if the required flowing amount differs between each of the plurality of adsorption modules, it has been necessary to drive the fan in accordance with the conditions requiring the most airflow. Therefore, there is concern over the energy consumption of the fan becoming high.

An object of the present disclosure is to provide a gas recovery device of aggregate module type having a plurality of adsorption modules, and no separately providing a dedicated fan corresponding to each adsorption module, and reduces the work of the fan, and thus can reduce the energy used in gas adsorption operation.

The present disclosure solves this problem by way of the following such means. It should be noted that, in order to facilitate understanding, a description is provided by assigning reference symbols corresponding to the embodiments of the present disclosure; however, it is not to be limited thereto.

A first aspect of the present invention relates to a gas recovery device (1) including: a plurality of modules (11), each including a sorbent material (12) inside thereof, and executing an adsorption process of aspirating a gas containing a recovery target gas and adsorbing the recovery target gas to the sorbent material (12); and a desorption process of desorbing the recovery target gas from the sorbent material (12) by heating in a state where a periphery of the sorbent material (12) is reduced pressure; and a fan (61) provided in a smaller quantity than a quantity of the plurality of modules (11), and supplying a gas to inside of the plurality of the modules (11), in which each of the plurality of the modules (11) includes valves (23, 24) respectively at an inlet and an outlet of the gas, and at least one of the valves (23, 24) has a valve aperture which varies according to an adsorption progression of the adsorption target gas in the module (11) to which the valve (23, 24) is provided.

According to a second aspect of the present invention, in the gas recovery device (1) as described in the first aspect, at least one of the valves (23, 24) has a valve aperture which becomes smaller with an elapse of adsorption time of the recovery target gas.

According to the present disclosure, it is possible to provide a gas recovery device of aggregate module type having a plurality of adsorption modules, and no separately providing a dedicated fan corresponding to each adsorption module, and reduces the work of the fan, and thus can reduce the energy used in gas adsorption operation.

### BRIEF DESCRIPTION OF THE DRAWINGS

FIG. 1 is a schematic diagram showing a configuration related to a flow of a liquid in a carbon dioxide recovery device 1, which is a gas recovery device according to an embodiment of the present invention;

FIG. 2 is a schematic diagram showing a configuration related to a flow of a gas in a module 11 of the carbon dioxide recovery device 1 according to the present embodiment;

FIG. 3 is a view showing an example of a connection configuration of the modules 11 and a fan 61;

FIG. 4 is a view showing a configuration example of the module 11, and also showing a part of the inside of the module 11;

FIG. 5 is a view showing an example of an internal configuration of a third valve 23;

FIG. 6 is a view showing an example of an internal configuration of a fourth valve 24;

FIG. 7 is a graph showing the evolution of CO₂ concentration at an adsorption module outlet in the case of giving, to the sorbent material module having an initial CO₂ adsorption amount of 0, an air flowrate including CO₂ equal to the CO₂ adsorption rate demonstrated by the sorbent material when the adsorption amount is 0;

FIG. 8 is a graph showing the evolution of the adsorption amount at the same conditions as FIG. 7;

FIG. 9 is a graph prepared by adding explanations to FIG. 8 showing the evolution of the adsorption amount;

FIG. 10 provides graphs showing a demanded air flowrate which varies according to progression of processing in each module and the valve aperture;

FIG. 11 is a graph showing the relationship between the aperture of a butterfly valve 24a and the air flowrate;

FIG. 12 is a view showing the air flowrate through each module, in the case of setting the aperture of the butterfly valve 24a of all modules to an aperture realizing an air flowrate including the CO₂ flowrate conforming to an adsorption amount QH at the start of adsorption; and

FIG. 13 is a view showing an air flowrate through each module, in the case of respectively setting the aperture of the butterfly valve 24a of each module to an aperture realizing an air flowrate including the CO₂ flowrate conforming to the progression of the adsorption amount QH of each module.

### DETAILED DESCRIPTION OF THE INVENTION

Hereinafter, embodiments of the present invention will be described by referencing the drawings.

### Overall Configuration

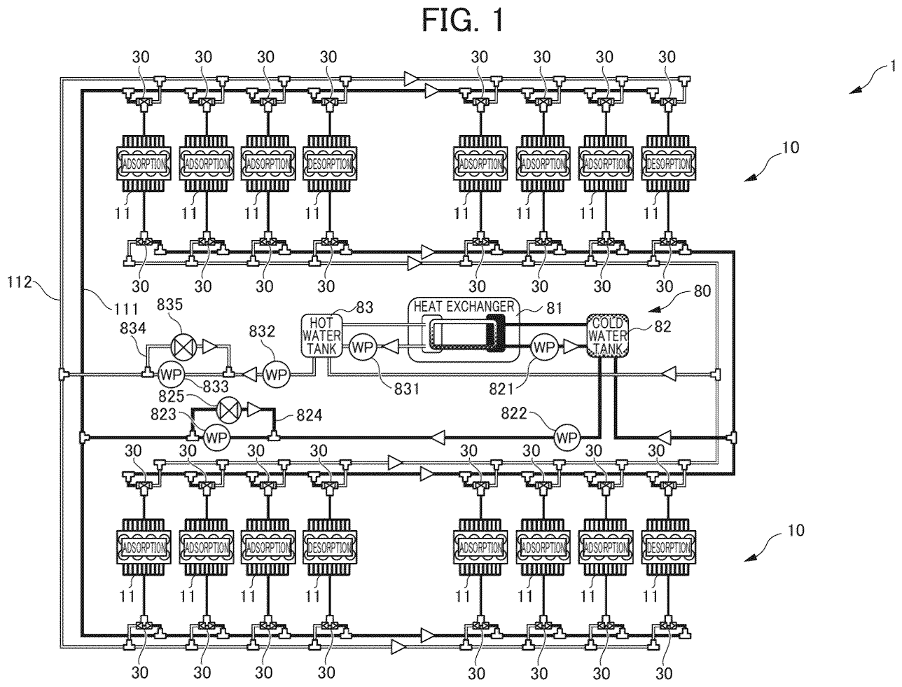

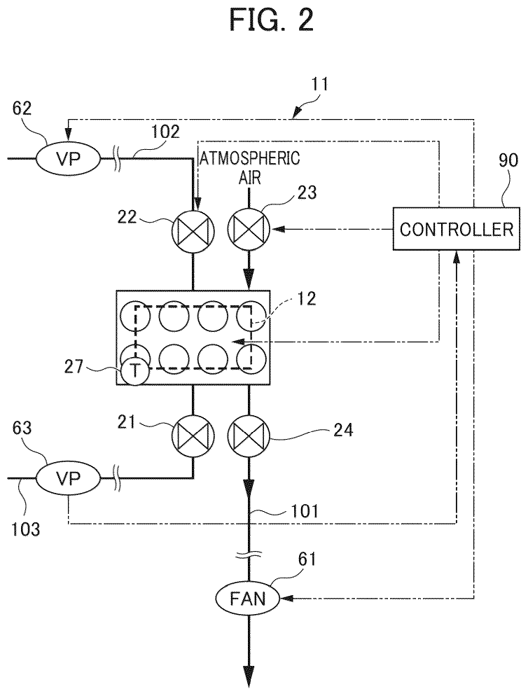

FIG. 1 is a schematic diagram showing a configuration related to a flow of a liquid in a carbon dioxide recovery device 1, which is a gas recovery device according to an embodiment of the present invention. FIG. 2 is a schematic diagram showing a configuration related to a flow of a gas in a module 11 of the carbon dioxide recovery device 1 according to the present embodiment. It should be noted that illustrations of configurations related to the flow of gas in the carbon dioxide recovery device 1 in FIG. 1 are omitted. It should be noted that, in the following description, although described by illustrating the carbon dioxide recovery device 1 which is an example of a gas recovery device, the configuration of metering control using the valves of the present disclosure is similarly applicable to a case of recovering another gas other than carbon dioxide.

The carbon dioxide recovery device 1 of the present embodiment, for example, is applied to direct air recovery technology (DAC: Direct Air Capture) which recovers the carbon dioxide in the atmosphere, in order to decrease the carbon dioxide concentration in the atmosphere. The carbon dioxide recovered by the carbon dioxide recovery device 1 is stored in the ground, and is reused as a fuel or raw material.

As shown in FIGS. 1 and 2, the carbon dioxide recovery device 1 according to the present embodiment includes a module unit 10, a fan 61, a vacuum pump 62, a carbon dioxide recovery pump 63, a heat exchange device 80, and a controller 90.

The module unit 10 is configured by a plurality of the modules 11 which adsorb carbon dioxide being arranged in a line. In the present embodiment, a total number of sixteen of the modules 11 are arranged by a pair of left and right module units 10.

As shown in FIG. 2, the module 11 is a carbon dioxide recovery module which includes a sorbent material 12, a first valve 21, a second valve 22, a third valve 23, a fourth valve 24, and a sorbent material temperature sensor 27.

The sorbent material 12 is arranged inside of the module 11 in order to adsorb carbon dioxide. The sorbent material 12 is a member in particle form, and has a property of adsorbing carbon dioxide in a low-temperature state (for example, range of −30° C. to 50° C.), and desorbing (releasing) carbon dioxide in a state of high temperature (for example, range of 50° C. to 110° C.) and low concentration of carbon dioxide in the surroundings. As such a sorbent material 12, for example, a carbon dioxide sorbent material of a solid amine configured by supporting an amine on a porous material such as silica, or the like can be exemplified.

The first valve 21 is a switching value arranged at a connection of the module 11 with a carbon dioxide line 103 recovering the carbon dioxide. A carbon dioxide recovery pump 63 is arranged in the carbon dioxide line 103. The second valve 22 is a switching valve arranged at a connection of the module 11 with the vacuum line 102 in which the vacuum pump 62 is arranged. The third valve 23 is a switching value arranged at an inlet which suctions atmospheric air, etc. into the module 11. The fourth valve 24 is a switching valve arranged at a connection of the module 11 with an adsorption line 101. A fan 61 is arranged in the adsorption line 101.

The first valve 21, the second valve 22, the third valve 23 and the fourth valve 24 are all controlled to open and close by the controller 90. The first valve 21, the second valve 22, the third valve 23 and the fourth valve 24, for example, are configured by butterfly valves which are normal open.

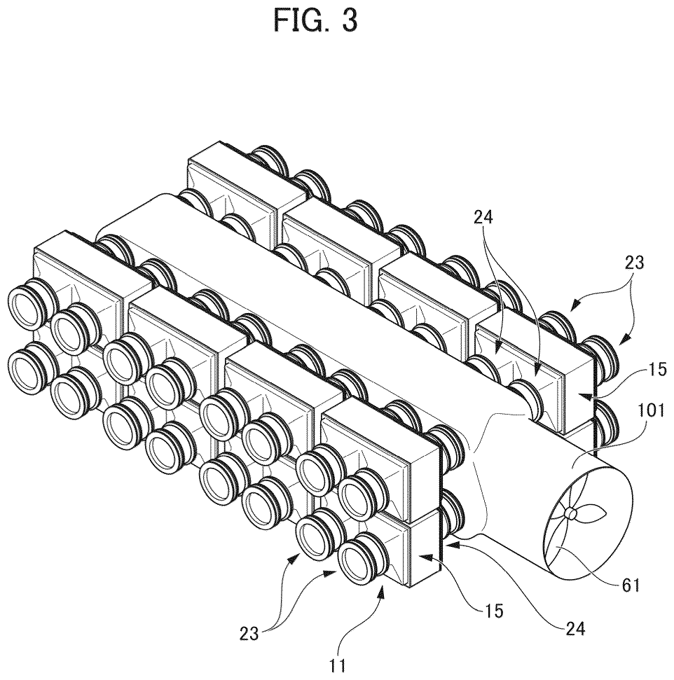

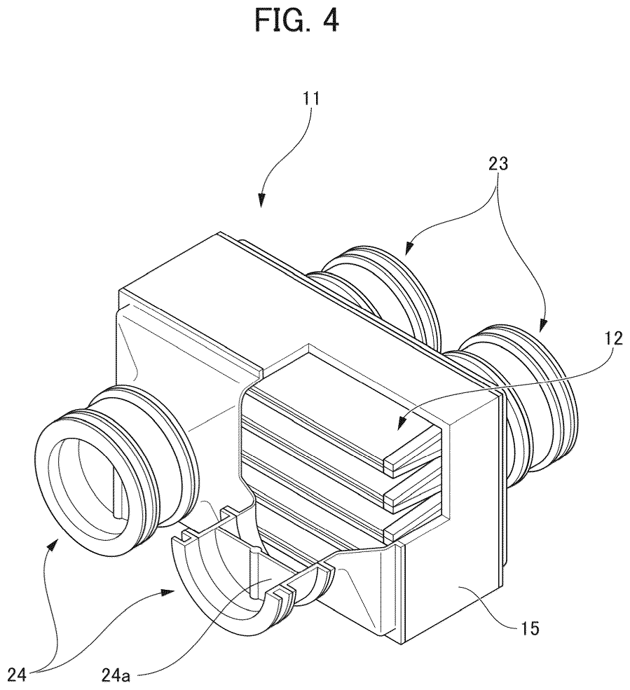

FIG. 3 is a view showing an example of a connection configuration of the modules 11 and the fan 61. FIG. 4 is a view showing a configuration example of the module 11, and also showing a part of the inside of the module 11. The example shown in FIG. 3 includes a total of sixteen modules 11, eight per side, on two sides opposing in a direction orthogonal to an extending direction (longitudinal direction) of a pipe which is the adsorption line 101. These modules 11 are connected to the adsorption line 101 by the fourth valves 24, and are provided to be arranged in parallel to the adsorption line 101. In other words, the adsorption line 101 is branched to connect to each of the respective modules 11. It should be noted that the arrangement of modules 11 relative to the adsorption line 101 shown in FIG. 3 is one example, and may be established as another arrangement than this.

As shown in FIG. 4, the module 11 includes a box-shaped housing 15, a heat exchange portion 16 arranged inside this, and the third valve 23 and the fourth valve 24 provided to the two opposing surfaces of a housing 15. The housing 15 is a box-shaped member, and includes the sorbent material 12 inside thereof. The sorbent material 12 is filled between the fins of a support body which includes a plurality of fins of thin plate shape, and a tube (pipe) which is not shown, the fins being layered in a bellows shape, for example, as shown in FIG. 4.

One fan 61 is provided at a portion at which the branching parts of the adsorption line 101 merge together. The fan 61, by being driven, generates a flow of gas from “intake” to “exhaust” in each of the plurality of modules 11 arranged at the upstream side of the adsorption line 101. The atmospheric air is thereby supplied into the modules 11.

FIG. 2 shows an example in which one of each of the third valve 23 and the fourth valve 24 is provided to one module 11 to facilitate understanding. However, as shown in FIGS. 2 and 3, two of each may be provided to one module 11, or a number more than this may be provided thereto.

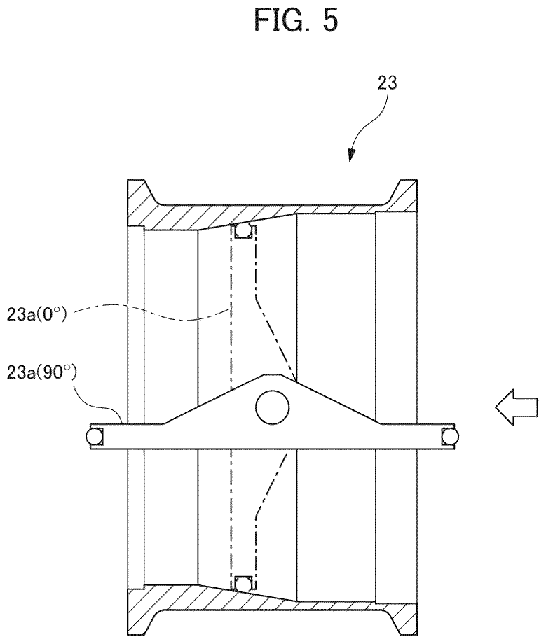

FIG. 5 is a view showing an example of the internal configuration of the third valve 23. The right side in FIG. 5 is the inlet side of atmospheric air, and the module 11 is connected to the left side thereof. As shown in FIG. 5, the third valve 23 includes an actuator (not shown) which is driven and controlled by the controller 90, and the butterfly valve 23a which rotationally operates by this actuator rotates between a fully closed state (0° state in FIG. 5) and a fully open state (90° state in FIG. 5). The third valve 23 thereby switches between blocking and introducing atmospheric air to flow into the module 11.

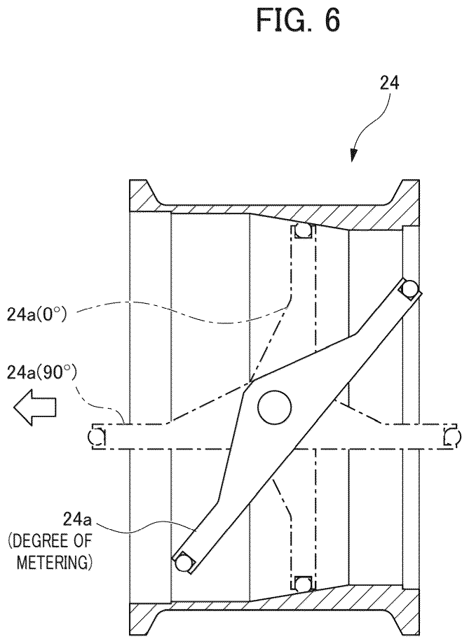

FIG. 6 is a view showing an example of the internal configuration of the fourth valve 24. The module 11 is connected to the right side in FIG. 6, and the fan 61 is connected to the left side via the adsorption line 101. As shown in FIG. 6, the fourth valve 24 includes an actuator (not shown) which is driven and controlled by the controller 90, and the butterfly valve 24a which rotationally operates by this actuator rotates between a fully closed state (0° state in FIG. 6) and a fully open state (90° state in FIG. 6). The fourth valve 24 thereby switches between blocking and introducing atmospheric air to flow into the module 11. In addition, the fourth valve 24 of the present embodiment is controlled by the controller 90 in the adsorption process, whereby the valve aperture varies according to the CO₂ adsorption progression in the module 11, and is set to valve apertures between the fully closed state and the fully open state (metering state in FIG. 6). It should be noted that FIG. 6 exemplifies a metering state of the butterfly valve 24a, and the aperture of this butterfly valve 24a continuously varies between a state of 0° and a state of 90°. More specifically, with the fourth valve 24 of the present embodiment, the valve aperture becomes smaller with the elapse of the CO₂ adsorption time in the adsorption process. Details of the adjustment (metering) of the valve aperture by this fourth valve 24 are described later.

Referring back to FIG. 2, the sorbent material temperature sensor 27 measures the temperature of the sorbent material 12. The measurement information of the sorbent material temperature sensor 27 is sent to the controller 90.

The vacuum line 102 is branched to connect to each of the respective modules 11. The vacuum pump 62 is arranged at a portion of the vacuum line 102 at which the branched portions merge together. The vacuum pump 62 aspirates gas inside of the module 11 through the vacuum line 102 by way of being driven to make the inside of the module 11 a vacuum state or bring it close to a vacuum state.

The carbon dioxide line 103 is branched to connect to each of the respective modules 11. At a portion of the carbon dioxide line 103 at which the branched portion merges, the carbon dioxide recovery pump 63 is arranged. The carbon dioxide recovery pump 63 causes the suction force to act on carbon dioxide flowing in the carbon dioxide line 103, and stores the recovered carbon dioxide in a tank (not shown) which stores carbon dioxide.

Referring back to FIG. 1, the heat exchange device 80 will be described. The heat exchange device 80, upon each module 11 of the module unit 10 performing the desorption process, supplies thermal energy for heating inside this module 11 up to a predetermined temperature. In addition, the heat exchange device 80 recovers thermal energy which is unneeded upon each module 11 performing the adsorption process.

The heat exchange device 80 of the present embodiment includes: a heat exchanger 81, a cold water tank 82, a cold water line 111, a hot water tank 83, a hot water line 112, and three-way valves 30.

The heat exchanger 81 performs heat exchange between a heat transfer medium flowing in the cold water line 111, and a heat transfer medium flowing in the hot water line 112. The heat exchanger 81, for example, is a heat pipe. The heat transfer medium, for example, is a liquid such as water. The heat transfer medium flowing in the cold water line 111 is cooled by the heat transfer occurring in the heat exchanger 81, and the heat transfer medium flowing in the hot water line 112 is heated.

The cold water tank 82 stores the heat transfer medium flowing in the cold water line 111. The heat transfer medium flowing in the cold water line 111 is stored in the cold water tank 82, and then is sent to the heat exchanger 81. In addition, the heat transfer medium cooled by the heat exchanger 81 is returned to the cold water tank 82, and then is sent to each module 11 through the cold water line 111. A heat-exchanger circulation water pump 821 is arranged between the cold water tank 82 and the heat exchanger 81 in the cold water line 111. By driving heat-exchanger circulation water pump 821, the heat transfer medium flowing in the cold water line 111 circulates between the cold water tank 82 and the heat exchanger 81.

The cold water line 111 is branched to connect to the upstream side and the downstream side of each of the respective modules 11, and connects the cold water tank 82 with each of the modules 11. In addition, a first cold-water circulation water pump 822 and a second cold-water circulation water pump 823 are arranged between the cold water tank 82 and each module 11 in the cold water line 111. In addition, a circulation line 824 which returns from the downstream side to the upstream side of the second cold-water circulation water pump 823 is arranged in the cold water line 111. A circulation valve 825 is arranged in this circulation line 824.

The hot water tank 83 stores the heat transfer medium flowing in the hot water line 112. The heat transfer medium flowing in the hot water line 112 is stored in the hot water tank 83, and then sent to the heat exchanger 81. In addition, the heat transfer medium heated by the heat exchanger 81 is returned to the hot water tank 83, and then sent to each module 11 through the hot water line 112. A heat-exchanger circulation water pump 831 is arranged between the hot water tank 83 and the heat exchanger 81 in the hot water line 112. By driving the heat-exchanger circulation water pump 831, the heat transfer medium flowing in the hot water line 112 circulates between the hot water tank 83 and the heat exchanger 81.

The hot water line 112 is branched to connect to the upstream side and the downstream side of each of the respective modules 11, and connects the hot water tank 83 and each module 11. In addition, a first hot-water circulation water pump 832 and a second hot-water circulation water pump 833 are arranged between the hot water tank 83 and each module 11 in the hot water line 112. In addition, a circulation line 834 which returns from the downstream side to the upstream side of the second hot-water circulation water pump 833 is arranged in the hot water line 112. A circulation valve 835 is arranged in this circulation line 834.

The three-way valve 30 is connected to the cold water line 111, the hot water line 112 and the module 11. Three-way valves 30 are respectively arranged at the upstream side and the downstream side of the module 11. The three-way valve 30 is configured to be switchable between a cold-water connection state connecting the cold water line 111 and the module 11, a hot-water connection state connecting the hot water line 112 and the module 11, and a closed state blocking connection between the cold water line 111 and the hot water line 112 with the module 11.

The flow path switching of the three-way valve 30 is controlled by the controller 90. The heat transfer medium is introduced to the module 11 through the three-way valve 30 arranged on the upstream side, and the heat transfer medium is returned to the heat exchanger 81 side through the three-way valve 30 arranged on the downstream side.

Next, the controller 90 will be described. The controller 90 controls the operation of each part of the carbon dioxide recovery device 1. The controller 90 controls operations such as driving and stopping of devices used in the adsorption and desorption of carbon dioxide. The controller 90 performs switching control, etc. of the first valve 21, the second valve 22, the third valve 23 and the fourth valve 24 provided to each module 11. In addition, the controller 90 performs driving control of the fan 61, the vacuum pump 62, the carbon dioxide recovery pump 63, the heat-exchanger circulation water pump 821, the first cold-water circulation water pump 822, the second cold-water circulation water pump 823, the heat-exchanger circulation water pump 831, the first hot-water circulation water pump 832 and the second hot-water circulation water pump 833, and switching control of the circulation valve 825 and the circulation valve 835.

The controller 90, for example, is a computer that has a CPU (Central Processing Unit), ROM (Read Only Memory), RAM (Random Access Memory), etc. The controller 90 may be configured as one unit, or may be configured by several units.

### <Recovery of Carbon Dioxide>

Next, control for recovering carbon dioxide by the controller 90 will be described. The carbon dioxide recovery device 1 removes and recovers carbon dioxide from the air by alternately performing an adsorption process of adsorbing carbon dioxide in a gas aspirated such as atmospheric air to the sorbent material 12 in the module 11, and a desorption process of desorbing the carbon dioxide adsorbed to the sorbent material 12, and then compresses the desorbed carbon dioxide and stores in a tank (not shown). In the present embodiment, the adsorption process and the desorption process are performed with a time of adsorption process: a time of desorption process=7:1.

The adsorption process is a process of adsorbing carbon dioxide to the sorbent material 12 inside the module 11. In the adsorption process, the third valve 23 and the fourth valve 24 of the module 11 are opened, and the first valve 21 and the second valve 22 are closed. The fan 61 is driven, whereby a flow of gas from upstream to downstream is generated, and the gas containing carbon dioxide (for example, atmospheric air) is aspirated through the third valve 23. The aspirated gas passes through the sorbent material 12 inside the module 11. At this time, the inside of the module 11 is room temperature (25° C.), and the carbon dioxide in the gas is adsorbed to the sorbent material 12. Gas other than carbon dioxide, for example, nitrogen, oxygen, etc., is exhausted to outside of the carbon dioxide recovery device 1 through the fourth valve 24 and the adsorption line 101. In addition, in the present embodiment, adjustment (metering) of the valve aperture by the fourth valve 24 is performed in this adsorption process.

The desorption process is a process of desorbing the carbon dioxide on the sorbent material 12 within the module 11. In the desorption process, the first valve 21, the third valve 23 and the fourth valve 24 of the module 11 are closed, and the second valve 22 is opened. The vacuum pump 62 runs to aspirate inside of the module 11, and reduces the pressure to a vacuum state or brings it close to a vacuum state. Simultaneously, the heat transfer medium serving as a heat source flows with the module 11 to supply thermal energy by way of the heat exchange device 80, whereby the sorbent material 12 of the module 11 is raised in temperature.

By temperature-rise control of the sorbent material 12, the sorbent material 12 is also heated to a predetermined temperature (for example, 80° C.) adequate for the desorption process, and the carbon dioxide adsorbed to the sorbent material 12 is desorbed. Next, the second valve 22, the third valve 23 and the fourth valve 24 are closed, the first valve 21 is opened, and the carbon dioxide recovery pump 63 is driven, whereby the carbon dioxide desorbed through the carbon dioxide line 103 is stored in a tank (not shown). In the present embodiment, the respective processes are controlled so that, among the sixteen of the modules 11, twelve of them execute the adsorption process, and the remaining four perform the desorption process.

### <Adjustment (Metering) of Valve Aperture by Fourth Valve 24>

As described previously, for the fourth valve 24 of the present embodiment, the valve aperture becomes smaller with the elapse of CO₂ adsorption time in the adsorption process. This is control corresponding to the adsorption rate of CO₂ in the module 11 changing according to the elapse of time since the adsorption start. At the time of CO₂ adsorption start, adsorption carries out very quickly on the sorbent material 12; however, the adsorption rate gradually weakens as adsorption progresses, and ultimately becomes asymptotic to an equilibrium adsorption amount, which is a state in which almost no adsorption takes place. Therefore, the supplied amount of atmospheric air required to supply to the module 11 gradually becomes smaller as adsorption progresses. Consequently, in the present embodiment, control is performed so that the valve aperture becomes smaller with the elapse of the CO₂ adsorption time in the adsorption process, and optimization of the supplied amount of atmospheric air to each module is performed. By this control, sufficient supply of atmospheric air required in the plurality of provided modules 11 will be performed. Therefore, since the supplied air flow required to the fan 61 can also be optimized, in the present embodiment, the workload of the fan 61 is greatly reduced compared to conventional. Hereinafter, the workload reduction effect of the fan will be described using the model of 8 modules illustrated by FIG. 3.

### <CO₂ Adsorption Progression of Sorbent Material in Adsorption Process>

First, CO₂ adsorption evolution of the sorbent material in the adsorption process will be described. In the following description, a mass transfer coefficient k, equilibrium adsorption amount Q*, initial adsorption amount Q0, and air CO₂ concentration are defined as the following values.
mass transfer coefficient k: k=4×10⁻⁴ (1/s)
equilibrium adsorption amount Q*: 2.3 (mol/kg)
initial adsorption amount Q0: Q0=0 (mol/kg)
air CO₂ concentration: C=400 (ppm)

In addition, assuming a configuration in which eight of the adsorption modules are provided as exemplified in FIG. 3, the eight adsorption modules will be described with a model that sequentially performs adsorption and desorption by staggering the timings (hereinafter also called adsorption/desorption cycle operation). The ratio of the time length ta of the adsorption step flowing air to this adsorption module, to td, which is the total of the time length not involved in air flow, such as a pre-heating step for CO₂ desorption, and a further cooling step for adsorption preparation, shall be 7:1, as follows.

ta:td=7:1

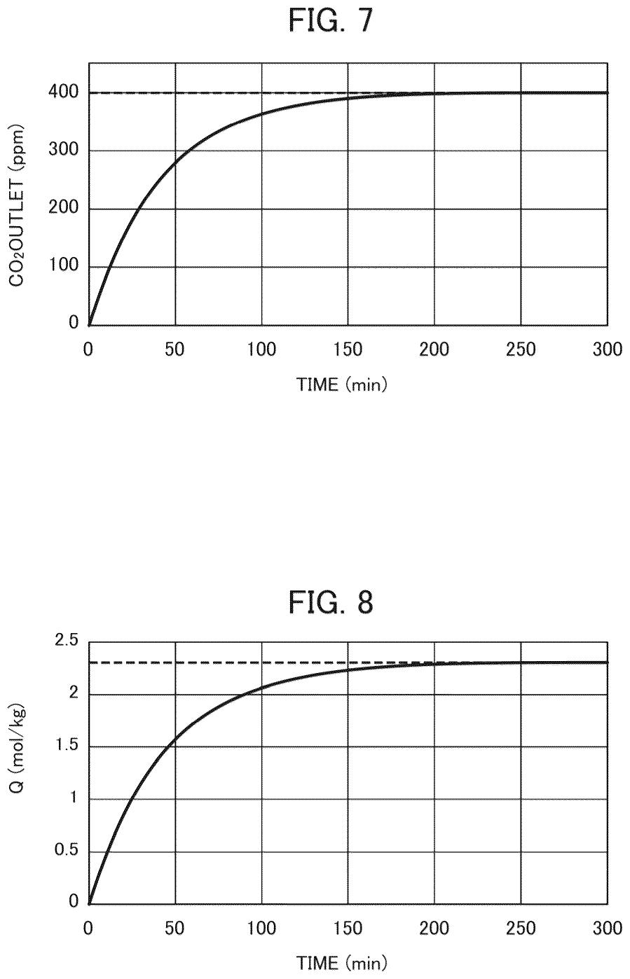

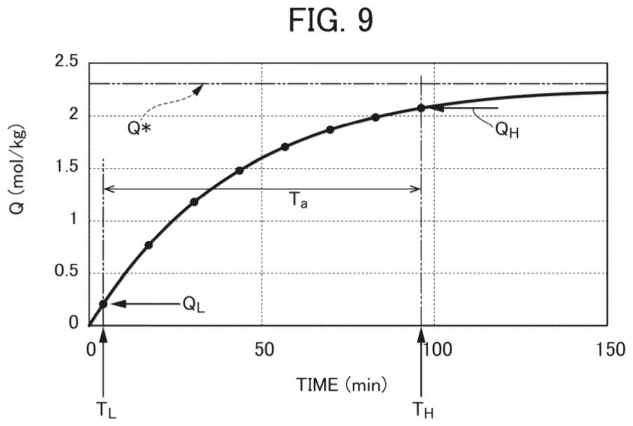

For the case of such a model, the evolution of CO₂ adsorption will be described. FIG. 7 is a graph showing the evolution of CO₂ concentration at an adsorption module outlet in the case of giving, to the sorbent material module having an initial CO₂ adsorption amount of 0, an air flowrate including CO₂ equal to the CO₂ adsorption rate demonstrated by the sorbent material when the adsorption amount is 0. FIG. 8 is a graph showing the evolution of the adsorption amount at the same configurations as FIG. 7.

The outlet CO₂ concentration exceeds 0 immediately after time 0, and becomes asymptotic to 400 (ppm) with the elapse of time, and synchronous with this, the adsorption amount increases from 0, and becomes asymptotic to the equilibrium adsorption amount 2.3 (mol/kg).

### <Operation of Carbon Dioxide Recovery Device>

FIG. 9 is a graph prepared by adding explanations to FIG. 8 showing the evolution of the adsorption amount. In actual adsorption/desorption cycle operation of the carbon dioxide recovery device, by the adsorption amount repeatedly reciprocating between QL, which is larger than 0, and QH, which is smaller than the equilibrium adsorption amount, CO₂ equivalent to the working capacity (ΔQ=QH−QL), which is the difference between QH and QL, is recovered every cycle.

An example will be described setting 80% working capacity relative to the equilibrium adsorption amount as follows.

QL=0.1Q*=0.23 (mol/kg)

QH=0.9Q*=2.07 (mol/kg)

### Therefore,

$$Δ Q = QH - QL = 0.8 {Q}^{★} = 1.84 ( mol / kg )$$

Measuring the time from time 0, when defining the time in which the adsorption amount reaches QL as tL, and defining the time at which reaching QH as tH, a time ta required in the adsorption step from QL to QH is as follows.

$$ta = tH - tL$$

In addition, the time Td from the moment of TH passing through the desorption step, etc., until the adsorption amount returns to QL again from QH is defined as follows.

$$td = ta / 7$$

When the working capacity in the cycle adsorption/desorption operation being in the range from 10% (defined as QL) and 90% (defined as QH) of the equilibrium adsorption amount Q*, for the cases of the following two types of air flowrate setting methods in the adsorption step, the superiority of this method will be described in principle by confirming the difference arising in the air introduction work (J) by a linear driving force model.
(1) Constant air flowrate driving: case of performing adsorption step in section from QL to QH, at an air flowrate (fixed value) conforming to QL.
(2) Adsorption amount feedback driving: case of performing adsorption step at air flowrate (time varying value) conforming to the adsorption amount Q transitioning from QL to QH.

In the constant air flowrate driving, in the case of performing the adsorption step with the air flowrate (constant value) conforming to QL, the air flowrate F_{AIR} (m³/s/kg) can be expressed as follows using the coefficient n which converts from mole to volume.

$$[ Expression 1 ]$$

$${F}_{AIR} = η \frac{dQ}{dt} {\vert}_{Q = {Q}_{L} = 0.1 Q *} = η k ( Q * - 0.1 Q \text{*)} = 0.9 η kQ * \qquad ( a )$$

According to the Ergun equation, which is an empirical formula expressing the pressure drop (Pa) in the adsorption layer filled with the particulate sorbent material, the pressure drop is configured by the sum of a first order proportional term and a second order proportional term of the superficial velocity of air flow (m/s) flowing into the adsorption layer; however, in the case of using a thin plate-shaped adsorption layer, it is known to be mostly dominated by the first-order component. In this case, it is possible to represent the pressure drop Pₐ (Pa) using the proportional coefficient τ, as follows.

$$[ Expression 2 ]$$

$${P}_{a} = τ {F}_{AIR} \qquad ( b )$$

Therefore, the pressure drop P_{w} (W/kg) can be expressed as follows.

$$[ Expression 3 ]$$

$${{{P}_{W} = {P}_{a} {F}_{AIR} = τ {F}_{AIR}^{2} = τ ( η k ( Q - 0.1 Q \text{*)} )}^{2} = τ ( η k 0.9 Q \text{*)}}^{2} \qquad ( c )$$

In the case of measuring the outlet CO₂ concentration of each adsorption module and the module flowrate, referencing the adsorption amount Q calculated from these, and performing the adsorption step at a flowrate (time varying value) conforming to the adsorption amount Q which transitions from QL to QH, the air flowrate F_{AIR′} (m³/s/kg) can be expressed as follows using the proportional coefficient η.

$$[ Expression 4 ]$$

$${F}_{AIR}^{′} = η k ( Q * - Q ) \qquad ( {a}^{′} )$$

Herein, in the case of adsorption starting with the sorbent material having an adsorption amount of 0 at time 0, the adsorption amount Q is expressed as follows as a function of time t.

$$[ Expression 5 ]$$

$$Q = Q * ( 1 - exp ( - kt ) ) \qquad ( d )$$

Herein, the above Formula (d) is a solution of the linear driving model: dQ/dt=k(Q*−Q). Therefore, the Formula (a′) can be rewritten as the following Formula (a″).

$$[ Expression 6 ]$$

$${F}_{{AIR}^{′}} = η kQ * exp ( - kt ) \qquad ( {a}^{″} )$$

The pressure drop P_{a′} (Pa) can be expressed as follows using (a″).

$$[ Expression 7 ]$$

$${P}_{{a}^{′}} = τ {F}_{{AIR}^{′}} \qquad ( {b}^{′} )$$

Therefore, the pressure drop P_{w′} (W/kg) can be expressed as follows.

$$[ Expression 8 ]$$

$${P}_{{W}^{′}} = {P}_{{a}^{′}} {F}_{{AIR}^{′}} = τ {F}_{{AIR}^{′}}^{2} = {τ ( η kQ * exp ( - kt ) )}^{2} \qquad ( {c}^{′} )$$

The pressure drops E (J/kg) and E′ (J/kg) are obtained by integrating Formulas (c) and (c′) by the time of the adsorption amount evolving from QL to QH; however, this time is obtained by calculating time t_{L} and time t_{H} considering that adsorption is progressing in Formula (d) from a state in which the adsorption amount is 0 in Formula (d). Time ti at QL and time t_{H} at QH can be expressed as follows.

$$[ Expression 9 ]$$

$$0.1 Q *= Q * ( 1 - exp ( - {kt}_{L} ) ) ∴ {t}_{L} = - {log}_{e} 0.9 / k \qquad ( e )$$

$$0.9 Q *= Q * ( 1 - exp ( - {kt}_{H} ) ) ∴ {t}_{H} = - {log}_{e} 0.1 / k \qquad ( f )$$

Therefore, the pressure drop E (J/kg) in the case of constant air flowrate control can be expressed as follows from Formula (c) with Formulas (d) and (e).

$$[ Expression 10 ]$$

$${E = τ ( η k ( Q * - 0.1 Q \text{*)} )}^{2} ( {t}_{H} - {t}_{L} ) = {τ ( 0.9 Q * η k )}^{2} ( {t}_{H} - {t}_{L} ) \qquad ( {c}_{2} )$$

The pressure drop E′ (J/kg) in the case of adsorption amount feedback control can be expressed as follows from Formulas (d) and (e) with Formula (c′).

$$[ Expression 11 ]$$

$${E}^{′} = {\int }_{{t}_{L}}^{{t}_{H}} {τ ( η kQ * exp ( - kt ) )}^{2} dt \qquad ( {c}_{2}^{′} )$$

Since k=4×10⁻⁴ (1/s) and Q*=2.3 (mol/kg), when applying this numerical value to Formulas (c2) and (c2′), the calculation conditions herein are as follows.

$$[ Expression 12 ]$$

$$E = 26586 \times {τη}^{2} {k}^{2} \qquad ( {c}_{3} )$$

$${E}^{′} = 4840 \times {τη}^{2} {k}^{2} \qquad ( {c}_{3}^{′} )$$

From the above, in the case of the working capacity being in the range of 10% (=QL) to 90% (=QH) of the equilibrium adsorption amount Q*, between a case of performing the adsorption step with a constant air flowrate conforming to QL, and a case of performing the adsorption step by conforming flowrate (time varying value) of the adsorption amount Q which progresses from QL to QH, it is found that the air introduction work (J) in the latter case is estimated to be 18.2% of the air introduction work of the former. It should be noted that this value of 18.2% is a value obtained by a comparison (4840/26586×100) of Formula (C₃) and Formula (C′₃) indicating pressure drop. The superiority of adsorption amount feedback driving which performs adjustment (metering) of the valve aperture by the fourth valve 24 proposed by the present disclosure can be confirmed in this way. It should be noted that, herein, although a model of ta:td=7:1 has been described, there will be similar results for the above superiority even if ta:td=3:1, for example. However, this reduction effect is a result of comparative evaluation with regard to the air introduction work (J/kg) contributed by the sorbent material.

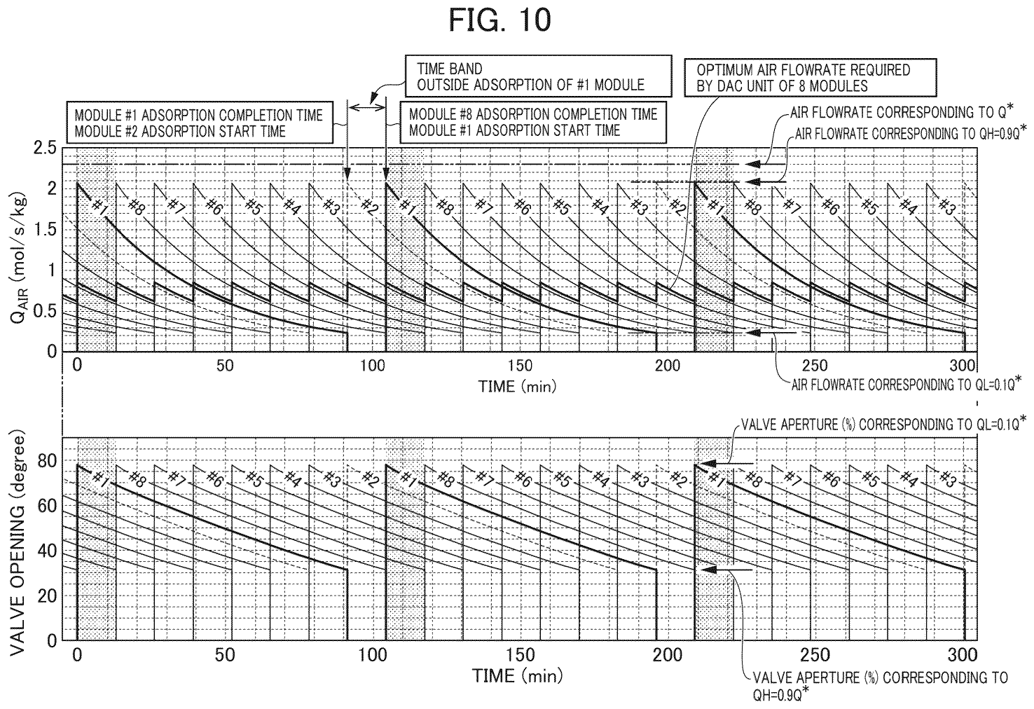

When establishing adsorption 7 modules+desorption 1 module=8 modules as one group, delaying the step time transition of each module relative to this group of 8 modules by (ta+td)/8, and configuring so that the adsorption completes in order, and then the desorption step is performed in order, as a whole, each module follows an order and adsorption progresses, with 7 modules always being in the adsorption process and one module being in the desorption process. In such a case, although the appropriate air flowrate required by the seven modules varies as in FIG. 10, the average value thereof (m³/s/kg) can be expressed as follows.

$$[ Expression 13 ]$$

$${F}_{{AIR}_{ave}} = η \frac{{Q}_{H} - {Q}_{L}}{{t}_{H} - {t}_{L}} = η \frac{0.8 Q *}{{t}_{H} - {t}_{L}} = η \frac{0.8 Q *}{- {log}_{e} 0.1 / k + {log}_{e} 0.9 / k} = 0.3641 η kQ * \qquad ( g )$$

On the other hand, the air flowrate F_{AIR}=F_{AIRconst} in the case of the constant air flowrate driving shown by Formula (a) can be expressed as follows.

$$[ Expression 14 ]$$

$${F}_{AIR} = {F}_{{AIR}_{const}} = 0.9 η kQ * \qquad ( a )$$

In other words, it was first ascertained that the air flowrate average value 0.3641ηkQ* required in the adsorption amount feedback driving is 40.46% relative to the flowrate of 0.9ηkQ* in constant air flowrate driving.

Next, the calculation method of pressure drop (J/kg) will be described. It is necessary to satisfy the requirements of pressure restriction, in that “The pressure drop (Pa) between the module upstream and downstream realized in constant air flowrate driving must occur similarly to the case of adsorption amount feedback driving which performs flowrate control by the downstream-side valve”. The reason for this requirement will be described below.

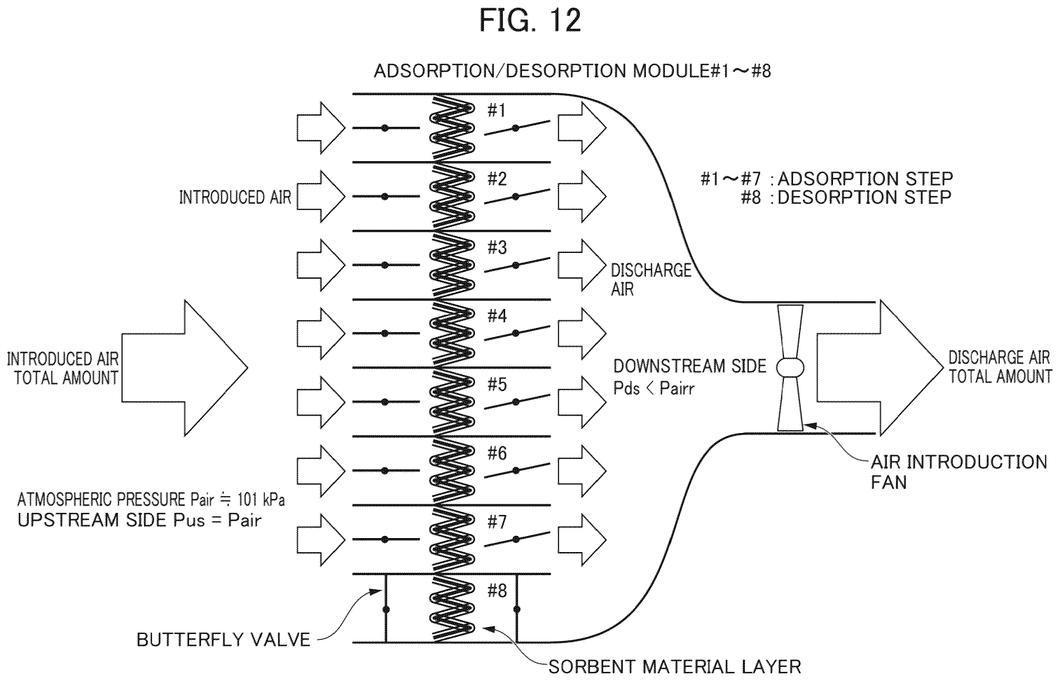

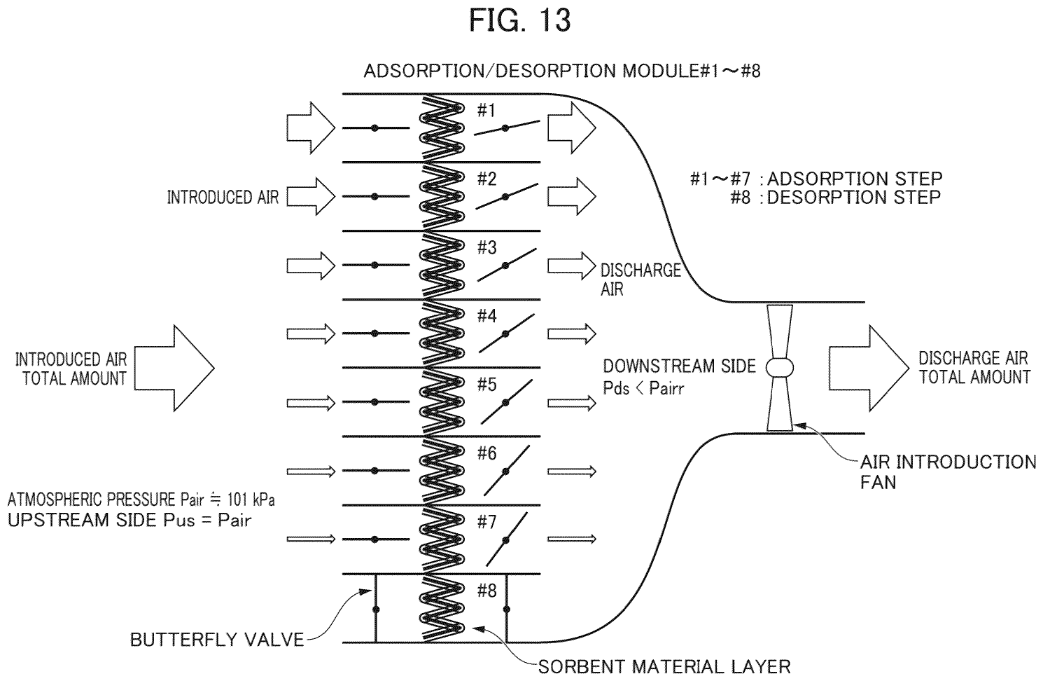

(1) As shown in FIGS. 12 and 13, the modules which are the burden are connected in parallel to the air introduction fan, then the pressure Pus outside of the air inflow-side valve of the module is constrained to atmospheric pressure Pair, and the air pressure Pds outside of the air outflow valve on the downstream side is constrained to a certain pressure value which is lower than the atmospheric pressure due to the driving force of the air fan, and this pressure difference Pus-Pds becomes the driving force, and in the case of the constant air flowrate driving, an air flowrate indicated by Formula (a) is generated.

(2) Similarly, in the case of adsorption amount feedback driving by this pressure difference, it is necessary to flow the air flowrate indicated by Formula (a) to the modules immediately after the start of the adsorption step. In other words, when this pressure difference does not exist, it is not possible to secure sufficient air flowrate required to the modules which just started the adsorption step. From the above (1) and (2), the necessity arises to satisfy the above requirements.

Based on the above requirements, in both the case of the constant air flowrate driving and the case of adsorption amount feedback driving, the pressure difference Pus-Pds (Pa) between the pressure on the outside of the upstream and downstream valves must be the same. Therefore, in the adsorption amount feedback driving, the pressure drop of the sorbent material itself decreases due to proper constricting of the air flowrate by the downstream-side valve, and the valve pressure drop is added so as to compensate the decrease in this sorbent material pressure drop (since valve pressure drop is decided by such logic, it is unnecessary to actually specify the type of valve, and so long as being a valve which can smoothly change the characteristic between fully open and fully closed irrespective of any flowrate characteristics of the valve, it will be possible to subject to flowrate control).

Under such conditions, the air flowrate differs between the two driving methods, and relative to the air flowrate 0.9ηkQ* in the case of constant air flowrate driving, since the flowrate average value 0.3641ηkQ* required in adsorption amount feedback driving is 40.46%, the latter is considered to have 40.46% the pressure drop (W/kg) of the former. 40.46% is the effect obtained in the present case study.

The relationship between the downstream-side valve aperture and the air flowrate in the case of constant air flowrate driving will be described with FIG. 12.
Module #1 (hereinafter also noted simply as #1; similar for other modules) to #7 are during adsorption step execution, and #8 is during desorption step execution.
Air flowrate corresponding to low-side adsorption amount QL=0.1Q* of working capacity is always supplied to the 7 modules in adsorption step.
#1 is early stage of adsorption step, #7 is final stage of adsorption step, and after the end of the desorption step of #8, #7 transitions to the desorption step, and simultaneously, #8 transitions to the adsorption step. It should be noted that, since the valve full open (90 degrees) is displayed as a state corresponding to Q=Q⁺, the valve aperture of each module equivalent to Q=QL is not 90 degrees (full open), but rather set to 78 degrees.

The relationship between the downstream-side valve aperture and air flowrate in the case of adsorption amount feedback driving will be described with FIG. 13.
Modules #1 to #7 are during execution of the adsorption step, and #8 is during execution of the desorption step.
The air flowrate according to the absorption amount of each module is supplied to the seven modules in the adsorption step.
#1 is early stage of adsorption step, and #7 is the final stage of adsorption step, and after the end of the desorption step of #8, #7 transitions to the desorption step, and simultaneously, #8 transitions to the adsorption step. It should be noted that, since the valve full open (90 degrees) is displayed as a state corresponding to Q=Q*, the valve aperture of each module equivalent to Q=QL is not 90 degrees (full open), but rather set to 78 degrees. In addition, the shaded time intervals in FIG. 10 correspond to the time band of the valve aperture shown in FIG. 13.

### <Required Air Flowrate and Valve Aperture>

FIG. 10 provides graphs showing a required air flowrate which varies according to progression of processing in each module and the valve aperture. The upper graph in FIG. 10 shows the air flowrate, and the lower graph shows the valve aperture. It should be noted that the air flowrate in FIG. 10 is indicated by flowrate per sorbent material unit mass (mol/s/kg). In FIG. 10, the reference numbers of the eight modules are indicated as “#1” to “#8”.

The air flowrate conforming to the maximum adsorption amount QH to give the working capacity is 2.07 (mol/s/kg) in FIG. 10. Each fine line assigned a reference number of the respective modules in FIG. 10 is an air flowrate conforming to the adsorption level of each module, and varies in the range of 2.07 to 0.23 mol/s/kg. In addition, the bold line of sawtooth shape is the total flowrate of the air flowrates conforming to the adsorption level of each module, and varies in the range of 0.62 to 0.85 mol/s/kg. Relative to a case of continually flowing the air flowrate conforming to the maximum adsorption amount QH, in a case of flowing the air flowrate conforming to the adsorption level of each module, the air introduction work for the sorbent material layer of the latter is 18.2% of the former. The bold line of sawtooth shape in FIG. 10 is the optimum air flowrate FAIR_opt (mol/s/kg) required by the carbon dioxide recovery device when steadily operating the carbon dioxide recovery device of eight modules in a constant environment.

### <Required Valve Aperture>

The valve aperture of each module (degree) can be shown as in the lower part of FIG. 10, from the “relationship between valve aperture and air flowrate” described later, and “required air flowrate” mentioned above. Herein, full closed is 0 deg, and full open is 90 deg. The valve aperture at minimum adsorption amount QL assumes a maximum of 78 deg, and the valve aperture at maximum adsorption amount QH assumes a minimum value of 31.7 deg. In FIG. 10, the solid line is the valve aperture of module number #1, and the broken line is the valve aperture of module number #2. Immediately after indicating the maximum adsorption amount, the valve aperture quickly approaches full closed. With the controller 90 similar to the example with this module number 8, it is possible to drastically reduce the workload demanded from the fan 61 of the present embodiment by controlling the fourth valve 24.

### <Required Air Flowrate>

The optimum air flowrate FAIR_opt (mol/s/kg) required by the carbon dioxide recovery device of eight modules obtained while steadily operating the carbon dioxide recovery device in a constant environment is the sawtooth form as previously described, with the maximum value of 6.83 and the minimum value of 4.99 relative to the average value of 5.89, and the variation of +16.0%, −15.2% exists relative to the average value. If carrying out flowrate feedback running so that the fan supplies the average value approximate of 5.89 (mol/g/kg), the electric power consumption of the blower fan can be sufficiently reduced; however, the adsorption/desorption profile of each module is slightly shifted from the target value.

In order to remedy this, flowrate feedback running may be performed so that the air flowrate of the fan becomes the optimum air flowrate FAIR_opt (mol/s/kg). In this case, the following (Phenomenon 1) occurs, while (Phenomenon 2) occurs.

(Phenomenon 1) The adsorption/desorption characteristic is the best, and thus the CO₂ yield (tCO₂/year) also reaches a maximum.

(Phenomenon 2) By the operating point of the fan somewhat varying, it is no longer possible to maintain the efficiency of the drive motor and the conversion efficiency of the fan at the best point.

Considering a balance of the above (Phenomenon 1) and (Phenomenon 2), it is possible to select constant control, variable control or something in between for the air flowrate. In the present embodiment, it is configured to maintain the operating state of the fan as constant as possible. It thereby becomes possible to set a combination of favorable region for fan and motor efficiency, and a favorable region for conversion efficiency from shaft input of the fan to air work, and a high-efficiency blower system can be established as a whole.

### <Relationship of Valve Aperture and Air Flowrate>

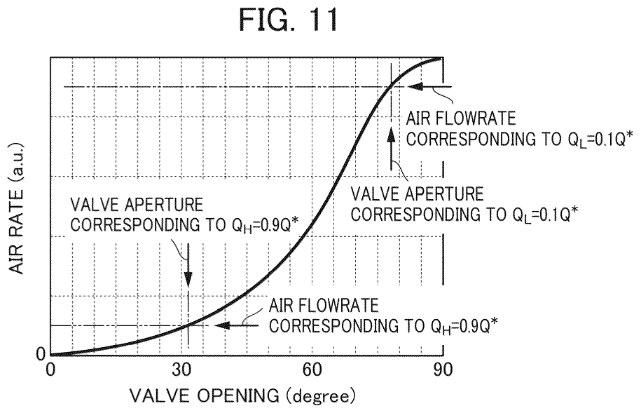

FIG. 11 is a graph showing the relationship between the aperture of the butterfly valve 24a and the air flowrate. In the case of the present embodiment, the pressure difference between the upstream and downstream of the fourth valve 24 is mostly constant; however, when controlling the flowrate using the butterfly valve 24a, there is a tendency to exhibit a characteristic suited to comparative flowrate control such as that shown in FIG. 11. Using this characteristic, it is possible to allocate the suitable air flowrate according to the adsorption amount of each module.

However, as mentioned previously, so long as being a valve which can smoothly change the characteristic between fully open and fully closed irrespective of any flowrate characteristics of the valve, it will be possible to subject to the above-mentioned flowrate control.

### <Estimation of CO₂ Adsorption Amount>>

The CO₂ adsorption amount can be directly estimated by measuring the CO₂ concentrations of the inlet and outlet of each module and the air flowrate of each module, and the valve aperture is controlled according to this estimated value. In this case, updating of the valve control is performed in consideration of the age-related deterioration in the adsorption characteristic of the module. In addition, the time history characteristic of adsorption may be saved in advance as a MAP, and the valve aperture may be adjusted in accordance thereto. Even in the case of control using such a MAP, it may be configured to detect the age-related deterioration in the adsorption characteristic by representatively using the CO₂ concentrations of the inlet and outlet of a unit, which is an assembly of the modules, then updating the valve control to reflect this, thereby curbing the performance degradation as a unit to the minimum.

As described above, according to the carbon dioxide recovery device 1 of the present embodiment, since the aperture of the fourth valve 24 is changed so as to be the appropriate aperture according to the extent of progress of carbon dioxide adsorption, it is possible to reduce the workload demanded from the fan 61.

### Modifications

Not limiting to the above described embodiments, various modifications and changes thereto are possible, and these are also within the scope of the present disclosure.

(1) An embodiment has been described giving an example of varying the aperture of the fourth valve 24 provided to the outlet side of the module 11 according to the extent of progression of carbon dioxide adsorption. Not limited to this, for example, it may be configured so as to vary the aperture of the third valve 23 provided to the inlet side according to the extent of progression of carbon dioxide adsorption, or may vary the valve apertures of both the third valve 23 and the fourth valve 24.

(2) An embodiment has been described giving an example establishing a configuration in which the time of the adsorption process:time of desorption process=7:1, by providing sixteen modules 11, and sequentially performing adsorption and desorption with groups of 8 modules. Not limiting to this, for example, the number of modules may be established as 24 or may be established as 32. In addition, for example, in the case of using a sorbent material for which 3:1 to appropriate as the time of adsorption process: time of desorption process, it is appropriate to implement by 3:1, and in this case, the modules 11 are selected as multiples of 4 such as 4 or 8. In other words, by considering the ratio of the time of adsorption process and time of the desorption process of the sorbent material, and considering the scale of the carbon dioxide recovery device 1, these numbers can adopt the appropriate values.

### EXPLANATION OF REFERENCE NUMERALS

1 carbon dioxide recovery device (gas recovery device)
10 module unit
11 module
12 sorbent material
15 housing
21 first valve
22 second valve
23 third valve
23a butterfly vale
24 fourth valve
24a butterfly valve
27 sorbent material temperature sensor
30 three-way valve
61 fan
62 vacuum pump
63 carbon dioxide recovery pump
80 heat exchange device
81 heat exchanger
82 cold water tank
83 hot water tank
90 controller
101 adsorption line
102 vacuum line
103 carbon dioxide line
111 cold water line
112 hot water line
400 with elapse of time
821 heat exchanger circulation water pump
822 first cold-water circulation water pump
823 second cold-water circulation water pump
824 circulation line
825 circulation valve
831 heat exchanger circulation water pump
832 first hot-water circulation water pump
833 second hot-water circulation water pump
834 circulation line
835 circulation valve

What is claimed is:

1. A gas recovery device comprising:
a plurality of modules, each including a sorbent material inside thereof, and executing an adsorption process of aspirating a gas containing a recovery target gas and adsorbing the recovery target gas to the sorbent material; and
a desorption process of desorbing the recovery target gas from the sorbent material by heating in a state where a periphery of the sorbent material is reduced pressure; and
a fan provided in a smaller quantity than a quantity of the plurality of modules, and supplying a gas to inside of the plurality of the modules,
wherein each of the plurality of the modules includes valves respectively at an inlet and an outlet of the gas, and
wherein at least one of the valves has a valve aperture which varies according to an adsorption progression of the adsorption target gas in the module to which the valve is provided.

2. The gas recovery device according to claim 1,
wherein at least one of the valves has a valve aperture which becomes smaller with an elapse of adsorption time of the recovery target gas.
